(19) United States
(12) Patent Application Publication
(10) Pub. No.: US 2008/0241684 A1
(43) Pub. Date: Oct. 2, 2008

(54) NONAQUEOUS ELECTROLYTE SECONDARY BATTERY AND METHOD FOR MANUFACTURING THE SAME

(76) Inventors: Yoshiyuki MURAOKA, Osaka (JP); Naoyuki Wada, Osaka (JP); Hajime Nishino, Nara (JP); Shinji Kasamatsu, Osaka (JP)

Correspondence Address: MCDERMOTT WILL & EMERY LLP, 600 13TH STREET, NW, WASHINGTON, DC, 20005-3096, US

(21) Appl. No.: 12/047,882

(22) Filed: Mar. 13, 2008

(30) Foreign Application Priority Data
Mar. 28, 2007 (JP) 2007-085130

(51) Int. Cl. H01M 4/02; H01M 4/04

(52) U.S. Cl. 429/209; 427/58

(57) ABSTRACT

A lithium ion secondary battery includes a positive electrode, a negative electrode, a porous insulating layer and a nonaqueous electrolyte. The porous insulating layer is provided between the positive electrode material mixture layer and the negative electrode material mixture layer and contains a material which does not have a shutdown function. The positive electrode is provided with a PTC layer extending substantially parallel to the positive electrode collector and the negative electrode is provided with a PTC layer extending substantially parallel to the negative electrode collector. Each of the PTC layers contains a material having a positive temperature coefficient of resistance.

### BACKGROUND OF THE INVENTION

1. Field of the Invention

The present invention relates to nonaqueous electrolyte secondary batteries and a method for manufacturing the nonaqueous electrolyte secondary batteries. In particular, it relates to a technology associated with safety of lithium ion secondary batteries.

2. Description of Related Art

With the rapid spread of portable and wireless electronic devices in recent years, there is a growing demand for use of small and lightweight secondary batteries having high energy density as driving power sources for these electronic devices.

Typical secondary batteries that meet the demand are nonaqueous electrolyte secondary batteries. A nonaqueous electrolyte secondary battery includes a positive electrode, a negative electrode, a separator and a nonaqueous electrolyte. The positive electrode includes a positive electrode active material supported on a positive, electrode collector and capable of electrochemically reacting with lithium ions (e.g., lithium cobalt composite oxide). The negative electrode includes a negative electrode active material supported on a negative electrode collector. In particular, the negative electrode active material may be an active material such as lithium metal, a lithium alloy or a lithium intercalation compound based on carbon as a host substance (the host substance is a substance capable of absorbing and desorbing lithium ions). The polyethylene separator is provided between the positive and negative electrodes such that it supports the nonaqueous electrolyte and prevents a short circuit from occurring between the positive and negative electrodes. The nonaqueous electrolyte may be an aprotic organic solution dissolving therein lithium salt such as LiClO₄ or LiPF₆.

For the manufacture of such a lithium ion secondary battery, the positive and negative electrodes are shaped into a thin film sheet or foil, respectively. Then, the positive and negative electrodes are stacked or wound in a spiral with the polyethylene separator interposed therebetween to obtain a power generating element. The power generating element is placed in a battery case made of stainless steel-plated or nickel-plated iron or aluminum and the nonaqueous electrolyte is poured into the battery case. Then, the battery case is sealed with a lid fixed thereon.

When the lithium ion secondary battery is overcharged or the short circuit (internal or external) occurs, the temperature of the lithium ion secondary battery increases. If the temperature of the lithium ion secondary battery exceeds the melting point of polyethylene (about 110° C.), the polyethylene separator is melted and the positive and negative electrodes are brought into contact. As a result, large current flows between the positive and negative electrodes. This is very dangerous because the lithium ion secondary battery may cause fire or smoke in some cases.

Under these circumstances, it has been proposed to provide the lithium ion secondary battery with a device for interrupting current when the temperature increases (current interrupting device: abbreviated as CID). In general, gas is generated in the lithium ion secondary battery with the temperature rise and the gas generation raises the pressure in the lithium ion secondary battery. The CID is configured to sense the pressure rise in the lithium ion secondary battery. When the pressure in the lithium ion secondary battery increases, the CID detects that the temperature of the lithium ion secondary battery has increased and interrupts the current flow.

Nevertheless, when the battery case is broken, the hermeticity of the lithium ion secondary battery becomes insufficient. In such a case, the CID cannot properly sense the pressure rise in the lithium ion secondary battery. Further, if an impact such as a drop impact is given to the lithium ion secondary battery, a CID failure may possibly occur. If the CID does not work properly, the current interruption is not carried out when the temperature of the lithium ion secondary battery increases. Therefore, the battery safety is cannot be ensured.

As insurance against the CID failure, according to Japanese Unexamined Patent Publication No. 2006-147569, a porous ceramic layer which does not melt at high temperature is used instead of the polyethylene separator. As the porous ceramic layer does not melt even if the temperature of the lithium ion secondary battery increases, a contact area between the positive and negative electrodes is less likely to increase if the short circuit occurs and large current is prevented from flowing between the positive and negative electrodes.

Further, according to Japanese Unexamined Patent Publication No. 6-231749, a heat sensitive resistance layer having a positive temperature coefficient of resistance is provided between the collector and the electrode material mixture layer such that the large current is prevented from flowing between the positive and negative electrodes even if the short circuit occurs.

### SUMMARY OF THE INVENTION

As described above, the temperature of the lithium ion secondary battery increases when the lithium ion secondary battery is overcharged and when the internal or external shirt circuit occurs in the lithium ion secondary battery. It is said that the rate of the temperature rise of the lithium ion secondary battery varies depending on the causes of the temperature rise, i.e., the overcharge, external and internal short circuits.

When the lithium ion secondary battery is overcharged or the external short circuit occurs, the temperature of the lithium ion secondary battery increases gradually. More specifically, when the lithium ion secondary battery is overcharged, i.e., when the lithium ion secondary battery is charged up to a voltage above the normal application range, there are still several minutes to several hours before the temperature of the lithium ion secondary battery reaches or exceeds a level at which thermal runaway starts (140° C. in general) after the lithium ion secondary battery falls into an abnormal state. In some cases, even if the charge is continued for several hours or more after the lithium ion secondary battery falls into the abnormal state, the temperature of the battery is still lower than the temperature at which the thermal runaway starts.

When the internal short circuit occurs in the lithium ion secondary battery, on the other hand, the temperature of the lithium ion secondary battery increases abruptly. More specifically, the temperature of part of the battery where the internal short circuit occurred reaches or exceeds the temperature at which the thermal runaway starts within a second after the occurrence of the internal short circuit. The temperature of the whole part of the lithium ion secondary battery also reaches or exceeds the temperature at which the thermal runaway starts within several seconds after the occurrence of the internal short circuit.

The porous ceramic layer disclosed by Japanese Unexamined Patent Publication No. 2006-147569 does not melt or contract even if the temperature of the lithium ion secondary battery increases. Therefore, a contact area between the positive and negative electrodes is less likely to increase. However, the porous ceramic layer does not have a current interrupting function, i.e., the current is not interrupted even when the temperature of the lithium ion secondary battery increases and the temperature rise cannot be stopped. Therefore, the technique disclosed by Japanese Unexamined Patent Publication No. 2006-147569 does not always ensure the safety of the lithium ion secondary battery.

The heat sensitive resistance layer disclosed by the Japanese Unexamined Patent Publication No. 6-231749 is able to increase its resistance value along with the increase in temperature. Therefore, the resistance value between the positive and negative electrodes is raised to prevent the flow of the large current. However, it is difficult for the heat sensitive resistance layer to raise the resistance value along with an abrupt temperature rise. Therefore, the temperature of the lithium ion secondary battery may further increase before the resistance value of the heat sensitive resistance layer is raised and the lithium ion secondary battery may fall into the abnormal state. Thus, the technique disclosed by Japanese Unexamined Patent Publication No. 6-231749 does not always ensure the safety of the lithium ion secondary battery.

Under these circumstances, the present invention is directed to ensure the safety of the battery both in the cases of the overcharge and the short circuit.

More specifically, a nonaqueous electrolyte secondary battery of the present invention includes a positive electrode, a negative electrode, a nonaqueous electrolyte, a porous insulating layer and a PTC (positive temperature coefficient) layer. The positive electrode includes a conductive positive electrode collector and a positive electrode material mixture layer supported on the positive electrode collector and contains lithium composite oxide. The negative electrode includes a conductive negative electrode collector and a negative electrode material mixture layer supported on the negative electrode collector and contains a negative electrode active material capable of electrochemically absorbing and desorbing lithium ions. The nonaqueous electrolyte is supported between the positive electrode and the negative electrode. The porous insulating film is provided between the positive electrode material mixture layer and the negative electrode material mixture layer and contains a material which does not have a shutdown function. The PTC layer is provided on at least one of the positive and negative electrodes to extend substantially parallel to at least one of the positive and negative electrode collectors and contains a material having a positive temperature coefficient of resistance.

The phrase “the electrode material mixture layer is supported on the collector” also indicates the case where the electrode material mixture layer is provided on the collector with another layer (e.g., a PTC layer) sandwiched therebetween and the case where the material mixture layer is provided on the surface of the collector.

The phrase “the PTC layer extends substantially parallel to the collector” also indicates the case where the PTC layer extends parallel to the collector, the case where the PTC layer is slightly inclined with respect to the collector, the case where the surface of the PTC layer is slightly irregular in the stacking direction of the electrode group and the case where the thickness of the PTC layer is uneven.

When a polyethylene separator is used as the porous insulating layer and the temperature of the nonaqueous electrolyte secondary battery increases, the separator is widely melted away from the short circuited part. As a result, a contact area between the positive and negative electrodes increases. Therefore, large current flows in the short circuited part between the positive and negative electrodes and thermal runaway occurs in the nonaqueous electrolyte secondary battery.

On the other hand, if the porous insulating layer contains the material that does not have the shutdown function as described above, the loss of the porous insulating layer is prevented even if the short circuit occurs in the nonaqueous electrolyte secondary battery. As a result, the contact area between the positive and negative electrodes is prevented from increasing and the large current is prevented from flowing therebetween. This slows the rate of the temperature rise in the nonaqueous electrolyte secondary battery when the short circuit occurs.

As described above, the PTC layer contains the material having the positive temperature coefficient of resistance. Therefore, when the nonaqueous electrolyte secondary battery is overcharged or the external short circuit occurs and the temperature of the battery exceeds a predetermined temperature, the resistance of the material having the positive temperature coefficient of resistance is raised to interrupt the current. As a result, the charge is finished before the thermal runaway occurs in the nonaqueous electrolyte secondary battery.

In a preferred embodiment described below, the PTC layer is provided at least between the positive electrode material mixture layer and the positive electrode collector or between the negative electrode material mixture layer and the negative electrode collector.

For example, if the PTC layer is provided between the positive electrode collector and the positive electrode material mixture layer and between the negative electrode collector and the negative electrode material mixture layer, the PTC layer and the positive electrode material mixture layer are sequentially stacked on the positive electrode collector, while the PTC layer and the negative electrode material mixture layer are sequentially stacked on the negative electrode collector. If the PTC layer is provided only between the positive electrode collector and the positive electrode material mixture layer, the PTC layer and the positive electrode material mixture layer are sequentially stacked on the positive electrode collector, while the negative electrode material mixture layer is directly provided on the surface of the negative electrode collector.

In another preferred embodiment described below, the positive electrode material mixture layer is provided on a surface of the positive electrode collector, the negative electrode material mixture layer is provided on a surface of the negative electrode collector and the PTC layer is provided in at least one of the positive electrode material mixture layer and the negative electrode material mixture layer.

The material which does not have the shutdown function is preferably at least one of a material which does not cause shutdown at a temperature lower than 130° C. but causes the shutdown at a temperature not lower than 130° C. and a material which does not cause the shutdown even at a temperature not lower than 130° C. The material which does not have the shutdown function is a metal compound in a preferred embodiment described below or a heat resistant polymer in another preferred embodiment described below.

If the material which does not have the shutdown function is the metal compound, the porous insulating layer preferably includes a metal compound layer containing the metal compound and an intermediate layer provided between the metal compound layer and at least one of the positive electrode material mixture layer and the negative electrode material mixture layer.

In the metal compound layer, metal compound particles are bonded together by a binder or the like. Therefore, the surface of the metal compound layer is uneven. The uneven surface of the metal compound layer is planarized by providing the intermediate layer as described above. Further, the provision of the intermediate layer makes it possible to prevent the metal compound layer from falling off the electrode plate when the electrode group is wound in a spiral.

If the material which does not have the shutdown function is a metal compound, it is preferably at least one of magnesia (MgO), silica (SiO₂), alumina (Al₂O₃) and zirconia (ZrO₂).

The material having the positive temperature coefficient of resistance may show a resistance value at a temperature of 80° C. to 130° C., both inclusive, which is 100 times or more higher than its resistance value at room temperature. The PTC layer may be a polymer PTC layer containing a conductive agent and a polymer material having a melting point of 80° C. to 130° C., both inclusive.

In the nonaqueous electrolyte secondary battery of the present invention, the porous insulating layer is preferably adhered to at least one of the positive electrode material mixture layer and the negative electrode material mixture layer.

In a preferred embodiment described below, the material having the positive temperature coefficient of resistance is scattered in the PTC layer.

A first method for manufacturing a nonaqueous electrolyte secondary battery of the present invention includes the steps of: (a) providing a PTC layer material containing a material having a positive temperature coefficient of resistance on a surface of a collector; (b) providing an electrode material mixture containing an active material having the same polarity as the collector on the PTC layer material; and (c) providing a porous insulating layer material containing a material which does not have a shutdown function on the electrode material mixture. According to this method, the PTC layer material is provided on at least one of the positive and electrode collectors.

A second method for manufacturing a nonaqueous electrolyte secondary battery of the present invention includes the steps of: (d) providing on a surface of a collector an electrode material mixture containing an active material having the same polarity as the collector; (e) providing a PTC layer material containing a material having a positive temperature coefficient of resistance on the electrode material mixture after the step (d); (f) providing the electrode material mixture on the PTC layer material; and (g) providing a porous insulating layer material containing a material which does not have a shutdown function on the electrode material mixture after the step (f). According to this method, the PTC layer material is provided in at least one of the positive and negative electrode material mixture layers.

### BRIEF DESCRIPTION OF THE DRAWINGS

FIG. 1 is a vertical sectional view illustrating the structure of a lithium ion secondary battery.

FIG. 2 is a sectional view illustrating the structure of an electrode group of Embodiment 1.

FIG. 3 is a graph illustrating a general temperature characteristic of a positive electrode active material.

FIGS. 4A to 4C are sectional views illustrating a method for manufacturing the electrode group of Embodiment 1.

FIG. 5 is a sectional view illustrating the structure of an electrode group of Embodiment 2.

FIG. 6 is a sectional view illustrating the structure of an electrode group of Embodiment 3.

FIG. 7 is an enlarged sectional view illustrating the structure of an electrode group of a comparative embodiment.

FIGS. 8A to 8C are sectional views illustrating a method for manufacturing the electrode group of Embodiment 3.

FIG. 9 is a sectional view illustrating the structure of an electrode group of Embodiment 4.

FIG. 10 is an enlargement of a region X shown in FIG. 9.

### DETAILED DESCRIPTION OF THE INVENTION

In advance of the explanation of embodiments of the present invention, how the inventors have developed the present invention will be described below.

As mentioned above, there is a demand for a nonaqueous electrolyte secondary battery (lithium ion secondary battery) which remains safe even if the overcharge or the short circuit occurs.

To meet the demand, the inventors of the present invention have made a study on the material of the porous insulating layer. As a result, they have found that a lithium ion secondary battery including a polyethylene separator as the porous insulating layer (hereinafter referred to as a “conventional lithium ion secondary battery”) may fall into a significantly dangerous state in some cases when an internal short circuit occurs in the battery. The inventors' finding will be explained before the explanation of the embodiments of the invention.

It has been known that the conventional lithium ion secondary battery falls into a dangerous state due to the melting of the separator when the internal short circuit occurs in the conventional lithium ion secondary battery. More specifically, when the internal short circuit occurs in the conventional lithium ion secondary battery, the temperature of the short circuited part instantly exceeds the melting point of polyethylene. Therefore, the separator starts to melt widely from the short circuited part. As a result, large short circuit current flows near the short circuited part and the temperature increases in the whole part of the conventional lithium ion secondary battery. Thus, the battery falls into the dangerous state.

The inventors of the present invention have found for the first time that the polyethylene separator is reacted with oxygen to generate heat once the temperature of the conventional lithium ion secondary battery reaches around 400° C. due to the melting of the separator. In other words, when the internal short circuit occurs in the conventional lithium ion secondary battery, heat is generated by the separator itself in addition to Joule heat associated with the short circuit current in the internal short-circuited part. The heat generated by the separator is not negligible and occupies about ⅓ of the total heat generated in the lithium ion secondary battery in some cases. That is, the provision of the polyethylene separator for ensuring the safety of the lithium ion secondary battery may impair the safety of the battery. Accordingly, the use of the polyethylene separator as the porous insulating layer is not preferable. The inventors has reached a conclusion that the separator is preferably made of a material having a melting point higher than that of polyethylene or a material which does not melt or contract even when the temperature of the lithium ion secondary battery increases.

In consideration of the case where the lithium ion secondary battery is overcharged or the external short circuit occurs in the battery, the lithium ion secondary battery is preferably configured such that the current is interrupted when the temperature increases gradually.

Based on the above-described results, the material having a melting point higher than that of polyethylene or the material which does not melt or contract even when the temperature of the lithium ion secondary battery increases is used as the porous insulating layer and the lithium ion secondary battery is configured such that the current is interrupted when the temperature increases gradually. Thus, the present invention has been achieved.

Hereinafter, embodiments of the present invention will be described in detail with reference to the drawings, but the present invention is not limited to the following embodiments. In the embodiments, substantially the same components may be indicated by the same reference numerals to omit the explanation.

### Embodiment 1

Embodiment 1 of the present invention takes a lithium ion secondary battery as an example of the nonaqueous electrolyte secondary battery. The structure of the lithium ion secondary battery will be explained below.

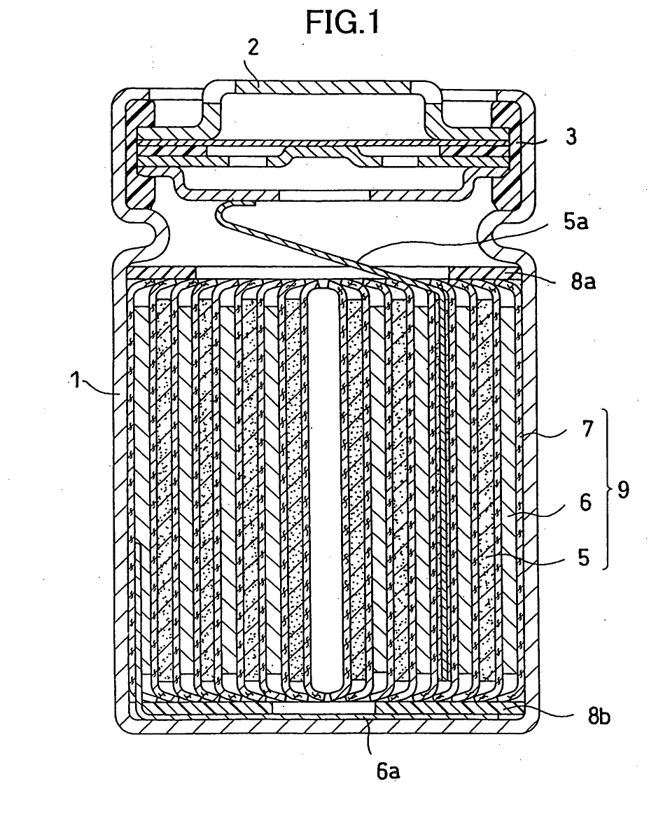

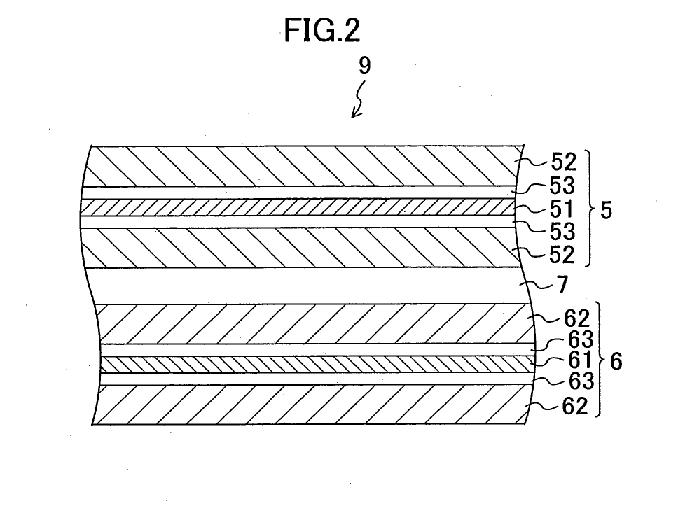

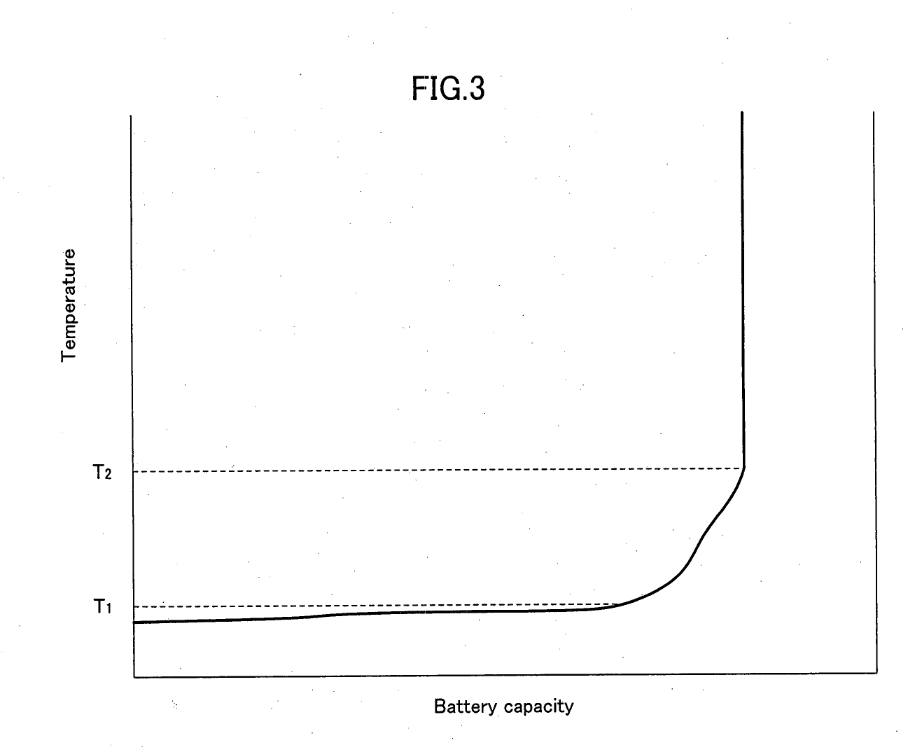

FIG. 1 is a vertical sectional view illustrating the structure of the lithium ion secondary battery of the present embodiment. FIG. 2 is a sectional view illustrating the structure of an electrode group 9 included in the lithium ion secondary battery of the present embodiment. FIG. 3 is a graph illustrating a general temperature characteristic of a positive electrode active material.

The lithium ion secondary battery of the present embodiment includes, as shown in FIG. 1, a stainless steel battery case 1 and an electrode group 9 placed in the battery case 1.

The battery case 1 has an opening 1a at the top thereof. A sealing plate 2 is crimped to the opening 1a with a gasket 3 interposed therebetween. The opening 1a is closed by crimping the sealing plate 2.

The electrode group 9 includes a positive electrode 5, a negative electrode 6 and a porous insulating layer 7. The positive electrode 5 and the negative electrode 6 together with the porous insulating layer 7 sandwiched between are wound in a spiral. A top insulator 8a and a bottom insulator 8b are arranged at the top and the bottom of the electrode group 9, respectively.

An aluminum positive electrode lead 5a is connected to the positive electrode 5 at one end and to the sealing plate 2 which also serves as a positive electrode terminal at the other end. A nickel negative electrode lead 6a is connected to the negative electrode 6 at one end and to the battery case 1 which also serves as a negative electrode terminal at the other end.

The positive electrode 5 includes, as shown in FIG. 2, a positive electrode collector 51, positive electrode material mixture layers 52 and PTC layers 53. The positive electrode collector 51 is a conductive plate. The positive electrode material mixture layers 52 are supported on the positive electrode collector 51 and contain a positive electrode active material (not shown, e.g., lithium composite oxide). The positive electrode material mixture layers 52 preferably contain a binder or a conductive agent in addition to the positive electrode active material. The PTC layers 53 are interposed between the positive electrode collector 51 and the positive electrode material mixture layers 52. The negative electrode 6 includes a negative electrode collector 61, negative electrode material mixture layers 62 and PTC layers 63. The negative electrode collector 61 is a conductive plate. The negative electrode material mixture layers 62 are supported on the negative electrode collector 61 and contain a negative electrode active material (not shown). The negative electrode material mixture layers 62 preferably contain a binder in addition to the negative electrode active material. The PTC layers 63 are interposed between the negative electrode collector 61 and the negative electrode material mixture layers 62.

Hereinafter, the porous insulating layer 7 and the PTC layers 53 and 63 will be explained in detail.

First, the porous insulating layer 7 is provided between the positive electrode material mixture layer 52 and the negative electrode material mixture layer 62. The porous insulating layer 7 is preferably adhered to one of the positive and negative electrode material mixture layers 52 and 62, more preferably to both of the positive and negative electrode material mixture layers 52 and 62. The porous insulating layer 7 keeps the positive and negative electrodes 5 and 6 insulated and supports a nonaqueous electrolyte (not shown). Therefore, the porous insulating layer 7 preferably has high ion permeability, a certain mechanical strength and a certain insulation property. Specific examples thereof are a thin microporous film, woven fabric or nonwoven fabric.

The porous insulating layer 7 contains a material which does not have a shutdown function.

The shutdown function is a function of interrupting a current flow by blocking the pores in the porous insulating layer. More specifically, when a polyethylene separator is used as the porous insulating layer and the temperature of the lithium ion secondary battery exceeds the melting point of polyethylene, the polyethylene separator is melted to block the pores in the porous insulating layer. Accordingly, the polyethylene separator has the shutdown function.

In the present embodiment, the material which does not have the shutdown function is a material which does not have the function of interrupting the current. In other words, it is a material which does not melt or contract and keeps working as the porous insulating layer 7 even if the temperature of the lithium ion secondary battery increases (130° C. or higher, e.g., 300° C.). With use of such a material, the porous insulating layer 7 does not melt away even if the temperature of the lithium ion secondary battery increases. Therefore, a contact area between the positive and negative electrodes 5 and 6 is less likely to increase. In this specification, the material that does not melt or contact in the lithium ion secondary battery even at high temperature is referred to as “high heat resistant material”.

Examples of the high heat resistant material include heat resistant polymers and metal compounds.

The heat resistant polymer is a polymer capable of withstanding continuous use at a high temperature not lower than 300° C. Therefore, the heat resistant polymer is able to insulate the positive and negative electrodes 5 and 6 at least at a temperature less than 300° C. Examples of the heat resistant polymer may include aramid (aromatic polyamide), polyimide, polyamide-imide, polyphenylene sulfide, polyether-imide, polyethylene terephthalate, polyether nitrile, polyether ether ketone, polybenzimidazole and polyallylate.

The metal compound may be metal oxide, metal nitride and metal sulfide, which are considered to be resistant up to a temperature not lower than 1000° C. Therefore, the metal compound is able to insulate the positive and negative electrodes 5 and 6 at least at a temperature less than 1000° C. Examples of the metal oxide used as the metal compound may include alumina (aluminum oxide; Al₂O₃), titania (titanium oxide; TiO₂), zirconia (zirconium oxide; ZrO₂), magnesia (magnesium oxide; MgO), zinc oxide (ZnO) and silica (silicon oxide; SiO₂).

The porous insulating layer 7 may be made of the heat resistant polymer only, the metal compound only or both of the heat resistant polymer and the metal compound. For the following two reasons, it is preferable that the porous insulating layer 7 contains the metal compound. One of the reasons is that the porous insulating layer 7 containing the metal compound is more heat resistant than the porous insulating layer 7 which does not contain the metal compound and keeps insulation between the positive and negative electrodes 5 and 6 at a higher temperature. Another reason is that the metal compound is solid even at high temperature and therefore minimizes the propagation of fire, if it happens in the lithium ion secondary battery. In order to obtain the effect of the use of the metal compound, magnesia (MgO), silica (SiO₂), aluminum oxide (Al₂O₃) or zirconium oxide (ZrO₂) is preferably used as the metal compound. If the porous insulating layer 7 contains the metal compound, metal compound particles are preferably bonded to each other by a binder.

The porous insulating layer 7 may contain other material than the heat resistant polymer, the metal compound and the binder. The other material than the heat resistant polymer, the metal compound and the binder is not particularly limited as long as it does not impair the function of the porous insulating layer 7. If a material which melts or contracts at around 100° C. is contained as the other material in addition to the heat resistant polymer, the metal compound and the binder, the content of the other material is preferably controlled to be very small such that it cannot function as the porous insulating layer as described in Embodiment 4 mentioned below.

Next, the PTC layers 53 and 63 will be explained.

The PTC layers 53 and 63 contain a material having a positive temperature coefficient of resistance, respectively. Therefore, at a temperature lower than a predetermined temperature (e.g., 80° C.), the PTC layers 53 and 63 function as conductor layers or semiconductor layers as they show low electronic resistance. When the temperature gradually increases and exceeds the predetermined temperature, the electronic resistance of the PTC layers 53 and 63 also increases along with the temperature rise. Therefore, the PTC layers 53 and 63 function as insulating layers. The PTC layer 53 covers the entire surface of the positive electrode collector 51, while the PTC layer 63 covers the entire surface of the negative electrode collector 61. Therefore, when the temperature of the lithium ion secondary battery gradually increases and exceeds the predetermined temperature, the positive electrode collector 51 and the positive electrode material mixture layer 52 are insulated from each other, while the negative electrode collector 61 and the negative electrode material mixture layer 62 are insulated from each other.

In general, the lithium ion secondary battery shows electron conductivity between the positive electrode active material and the positive electrode collector 51, as well as between the negative electrode active material and the negative electrode collector 61. Therefore, the lithium ion secondary battery is capable of charging and discharging. When the temperature of the lithium ion secondary battery of the present embodiment gradually increases, the positive electrode collector 51 and the positive electrode material mixture layer 52 are insulated from each other and the electron conduction between the positive electrode active material and the positive electrode collector 51 is blocked, and at the same time, the negative electrode collector 61 and the negative electrode material mixture layer 62 are insulated from each other and the electron conduction between the negative electrode active material and the negative electrode collector 61 are blocked. If the PTC layer 53 is provided to cover only a portion of the surface of the positive electrode collector 51, it is not preferable because large current flows into the positive electrode collector 51 through part of the surface of the positive electrode collector 51 where the PTC layer 53 is not provided.

The PTC layers 53 and 63 are conductor or semiconductor layers at a temperature lower than a predetermined temperature. Therefore, even if the PTC layers 53 and 63 are provided, it is possible to prevent a resistance value between the positive and negative electrodes 5 and 6 from increasing during normal operation (charge or discharge). Thus, the safety of the lithium ion secondary battery of the present embodiment is ensured without impairing battery performance (e.g., discharge performance, battery capacity and energy density).

Examples of the material having a positive temperature coefficient of resistance may include a material having a resistance value at a temperature of 80° C. to 130° C., both inclusive, which is 100 times or more higher than its resistance value at room temperature (around 20° C.) and a polymer PTC material.

The material having a resistance value at a temperature of 80° C. to 130° C., both inclusive, which is 100 times or more higher than its resistance value at room temperature may be BaTiMO₂ (M is one or more elements of Cr, Pb, Ca, Sr, Ce, Mn, La, Mn, Y, Nb and Nd). BaTiMO₂ behaves as a semiconductor at a temperature not higher than the Curie temperature, while it increases the resistance value by 100 times or more and behaves as an insulator at a temperature above the Curie temperature.

If the resistance value of BaTiMO₂ is raised at a temperature lower than 80° C., the lithium ion secondary battery may no longer be able to perform normal operation (charge or discharge) depending on its state of use. The temperature of the lithium ion secondary battery may increase up to around 80° C. during charge or discharge. Therefore, when the resistance value of BaTiMO₂ increases at a temperature lower than 80° C., the resistance value between the positive and negative electrodes 5 and 6 increases during the normal operation. In the case where the resistance value of BaTiMO₂ increases only after the temperature exceeds 130° C., thermal runaway may possibly occur in the lithium ion secondary battery before the resistance value increases. In either case, the safety of the lithium ion secondary battery is not ensured.

The lower limit of the temperature range is not limited to 80° C. and it may be 70° C. or 90° C. When the positive electrode active material shows a temperature characteristic as shown in FIG. 3, the lower limit is preferably placed between a temperature at which gradual temperature rise starts (T₁) and a temperature at which abrupt temperature rise begins (T₂). Likewise, the upper limit of the temperature range is not limited to 130° C. and it may be 120° C. or 140° C. When the positive electrode active material has a temperature characteristic as shown in FIG. 3, the upper limit is preferably established such that the temperature at which the abrupt temperature rise begins (T₂) lies between the lower limit and the upper limit of the temperature range. Further, the upper limit is preferably set at a temperature lower than the temperature at which the thermal runaway of the lithium ion secondary battery begins.

The amount of BaTiMO₂ to be applied to one surface of the collector is preferably 0.5 cm³/m² to 5 cm³/m², both inclusive. If the application amount of BaTiMO₂ is less than 0.5 cm³/m², it is not preferable because the effect of the application of BaTiMO₂ may not be obtained and the safety of the lithium ion secondary battery is not ensured. If the application amount of BaTiMO₂ exceeds 5 cm³/m², on the other hand, the effect of the application of BaTiMO₂ is obtained. However, it is not preferable because the battery performance may be impaired.

The polymer PTC material is a polymer film prepared by mixing a conductive agent into a polymeric material. The melting point of the polymeric material is 80° C. to 130° C., both inclusive. At low temperature, the current flows through conductive agent particles in an aggregated state in the polymer PTC material. When the temperature increases, the polymeric material is melted and thermally expanded to disperse the aggregated conductive agent particles. As a result, the conductivity of the polymer PTC material is lost.

Just like BaTiMO₂, the lower limit of the melting point of the polymeric material is not limited to 80° C. and it may be 70° C. or 90° C. The upper limit of the melting point of the polymeric material is not limited to 130° C. and it may be 120° C. or 140° C. If the polymeric material is configured to melt at a temperature significantly lower than 80° C., the resistance value of the polymer PTC material may increase at a temperature significantly lower than 80° C. This may possibly increase the resistance between the positive and negative electrodes 5 and 6 during the normal operation, depending on the state of use of the lithium ion secondary battery. Further, if the polymeric material is configured to melt only after the temperature significantly exceeds 130° C., the resistance value of the polymer PTC material increases only after the temperature significantly exceeds 130° C. Then, the thermal runaway may possibly occur in the lithium ion secondary battery before the resistance value of the polymer PTC material increases. Thus, the safety of the lithium ion secondary battery is not ensured.

Examples of the conductive agent contained in the polymer PTC material may include graphites such as natural graphite and artificial graphite, carbon blacks such as acetylene black (AB), Ketjen black, channel black, furnace black, lamp black and thermal black, conductive fibers such as carbon fiber and metal fiber, metal powders such as carbon fluoride and aluminum, conductive whiskers such as zinc oxide and potassium titanate, conductive metal oxides such as titanium oxide and organic conductive materials such as a phenylene derivative. The polymeric material may be polyethylene.

Each of the PTC layers 53 and 63 may be made of BaTiMO₂ only, the polymer PTC material only or both of BaTiMO₂ and the polymer PTC material. When the PTC layers 53 and 63 are made of BaTiMO₂ only, it is preferable that BaTiMO₂ particles are bonded to each other by a binder. If the PTC layers 53 and 63 contain BaTiMO₂, the BaTiMO₂ particles are preferably dispersed in the PTC layers 53 and 63.

Each of the PTC layers 53 and 63 may contain other material than BaTiMO₂ and the polymer PTC material. Although the content of the other material in the PTC layers 53 and 63 varies depending on the kind of the PTC layer material or the other material, the other material is preferably added in such an amount that does not impair the function of the PTC layer (the function of increasing the resistance with temperature rise).

The PTC layers 53 and 63 are considered to have reversibility. That is, when the lithium ion secondary battery falls into an abnormal state and the temperature of the battery increases to 80° C. or higher, the resistances of the PTC layers 53 and 63 increase. Thereafter, when the temperature of the lithium ion secondary battery decreases to a temperature lower than 80° C., the resistances of the PTC layers 53 and 63 also decrease. Thus, according to the present embodiment, the lithium ion secondary battery, even if it falls into the abnormal state, returns to the usable state if the temperature of the lithium ion secondary battery is reduced to a temperature lower than 80° C.

Hereinafter, the operation of the lithium ion secondary battery of the present embodiment will be explained.

Under the normal operation state, the temperature of the lithium ion secondary battery of the present embodiment does not greatly increase. At this time, the PTC layers 53 and 63 function as conductors or semiconductors. Therefore, even if both of the PTC layers 53 and 63 are provided, the resistance between the positive and negative electrodes 5 and 6 is less likely to increase in the normal operation.

When the lithium ion secondary battery of the present embodiment is overcharged, the temperature of the lithium ion secondary battery increases. However, since the temperature gradually increases at this time, the resistance values of the PTC layers 53 and 63 also increase along with the temperature rise. According to this mechanism, the resistance value between the positive and negative electrodes 5 and 6 increases to prevent the large current from flowing when the lithium ion secondary battery of the present embodiment is overcharged. Thus, in the lithium ion secondary battery of the present embodiment, the charging is finished with safety when the battery is overcharged.

In the case of an external short circuit, the temperature of the lithium ion secondary battery gradually increases. Therefore, the charge or discharge of the lithium ion secondary battery of the present embodiment can be finished with safety even if the external short circuit occurs.

When the internal short circuit occurs in the lithium ion secondary battery of the present embodiment, the temperature of the lithium ion secondary battery abruptly increases. Even if the abrupt temperature rise occurs, the porous insulating layer 7 does not melt away. Therefore, the contact area between the positive and negative electrodes 5 and 6 is less likely to increase. As a result, the charge or discharge of the lithium ion secondary battery of the present embodiment can be finished with safety even if the internal short circuit occurs.

As described above, the presence of the porous insulating layer 7 in the lithium ion secondary battery of the present embodiment makes it possible to keep the insulation between the positive and negative electrodes 5 and 6 even when the abrupt temperature rise occurs. On the other hand, when the temperature increases gradually, the presence of the PTC layers 53 and 63 makes it possible to increase the resistance between the positive and negative electrodes 5 and 6. Thus, regardless of whether the temperature rise occurs abruptly or gradually, the positive and negative electrodes 5 and 6 are kept insulated.

The inventors of the present invention have confirmed that the lithium ion secondary battery of the present embodiment is applicable in a wider range as compared with the conventional lithium ion secondary battery. To be more specific, it has been confirmed by the inventors of the present invention that the lithium ion secondary battery of the present embodiment is used with safety even in an environment where the temperature of the lithium ion secondary battery is less likely to increase (e.g., charge at low ambient temperature or charge at low current) and an environment where the temperature of the lithium ion secondary battery is likely to increase (e.g., charge at high ambient temperature or charge at high current). Details are as follows.

In the conventional lithium ion secondary battery, the current is interrupted only after the temperature of the lithium ion secondary battery exceeds the melting point of polyethylene. Therefore, when the conventional lithium ion secondary battery is used in an environment where the temperature of the lithium ion secondary battery is less likely to increase, the temperature of the lithium ion secondary battery may not exceed the melting point of polyethylene even if the battery falls into an abnormal state. That is, regardless of the abnormal state of the lithium ion secondary battery, the current may not be interrupted. Therefore, the safety of the conventional lithium ion secondary battery is not ensured in such an environment. In contrast, the lithium ion secondary battery of the present embodiment makes it possible to keep the positive and negative electrodes 5 and 6 insulated from each other in such an environment and therefore ensures the battery safety.

If the conventional lithium ion secondary battery is used in the environment where the temperature of the lithium ion secondary battery is likely to increase, the polyethylene separator is melted while the lithium ion secondary battery is normally operated. Once the polyethylene separator is melted, the lithium ion secondary battery is not charged or discharged any more. In contrast, the lithium ion secondary battery of the present embodiment is able to charge and discharge again even if it is exposed to high temperature because each of the PTC layers 53 and 63 has reversibility.

Hereinafter, materials of the positive electrode 5, negative electrode 6, porous insulating layer 7 and nonaqueous electrolyte will be described in order.

As to the positive and negative electrodes 5 and 6, materials for the positive and negative electrode collectors 51 and 61 and the positive and negative electrode material mixture layers 52 and 62 are not particularly limited and any known material can be used.

Each of the positive and negative electrode collectors 51 and 61 may be made of a long porous or nonporous conductive substrate. The positive electrode collector 51 may be made of a stainless steel plate, an aluminum plate or a titanium plate. The negative electrode collector 61 may be a stainless steel plate, a nickel plate or a copper plate. The thicknesses of the positive and negative electrode collectors 51 and 61 are not particularly limited. Their thicknesses are preferably 1 μm to 500 μm, both inclusive, more preferably 5 μm to 20 μm, both inclusive. If the thicknesses of the positive and negative electrode collectors 51 and 61 are in the above-described range, the strength of the positive and negative electrodes 5 and 6 is maintained and the weight of the positive and negative electrodes 5 and 6 is reduced.

Examples of the positive electrode active material may include LiCoO₂, LiNiO₂, LiMnO₂, LiCoNiO₂, LiCoMO_{z}, LiNiMO_{z}, LiMn₂O₄, LiMnMO₄, LiMePO₄ and Li₂MePO₄F (wherein M is at least one of Na, Mg, Sc, Y, Mn, Fe, Co, Ni, Cu, Zn, Al, Cr, Pb, Sb and B), as well as compounds obtained by substituting one of the elements of these lithium-containing compounds with a different element. The positive electrode active material may be surface-treated with metal oxide, lithium oxide or a conductive agent, e.g., by hydrophobization.

Among the above-listed examples, nickel-containing lithium composite oxide is preferably used as the positive electrode active material. This is because the nickel-containing lithium composite oxide has high electric capacitance and the use of the nickel-containing lithium composite oxide as the positive electrode active material makes it possible to achieve a high capacity lithium ion secondary battery.

It has been known that the nickel-containing lithium composite oxide is thermally unstable. However, even if the lithium composite oxide lacking thermal stability is used as the positive electrode active material, the stability of the positive electrode active material is ensured for the following reasons.

When the conventional lithium ion secondary battery falls in an abnormal state and its temperature increases, the polyethylene separator is melted and large current flows. As a result, the temperature of the lithium ion secondary battery further increases. That is, if the conventional lithium ion secondary battery using the nickel-containing lithium composite oxide as the positive electrode active material falls into the abnormal state, the positive electrode active material becomes unstable.

In contrast, when the lithium ion secondary battery of the present embodiment falls in the abnormal state, the insulation between the positive and negative electrodes is maintained and the large current is prevented from flowing. Therefore, even if the lithium ion secondary battery of the present embodiment using the nickel-containing lithium composite oxide as the positive electrode active material falls into the abnormal state, the positive electrode active material remains stable.

Examples of the negative electrode active material may include metal, metal fiber, a carbon material, oxide, nitride, a tin compound, a silicon compound and various alloys. Examples of the carbon material may include various natural graphites, coke, partially-graphitized carbon, carbon fiber, spherical carbon, various artificial graphites and amorphous carbon. Since the simple substances such as silicon (Si) and tin (Sn), the silicon compound and the tin compound have high capacitance density, it is preferable to use them as the negative electrode active material. Examples of the silicon compound may include SiOₓ (0.05<x<1.95) and a silicon alloy, a silicon compound and a silicon solid solution obtained by substituting part of Si with at least one of the elements selected from the group consisting of B, Mg, Ni, Ti, Mo, Co, Ca, Cr, Cu, Fe, Mn, Nb, Ta, V, W, Zn, C, N and Sn. The tin compound may be, for example, Ni₂Sn₄, Mg₂Sn, SnOₓ (0<x<2), SnO₂ or SnSiO₃. One of the examples of the negative electrode active material may be used solely or two or more of them may be used in combination.

The positive electrode material mixture layer 52 preferably contains a binder or a conductive agent in addition to the lithium composite oxide. The negative electrode material mixture layer 62 preferably contains a binder in addition to the negative electrode active material.

Examples of the binder may include PVDF (poly(vinylidene fluoride)), polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinyl pyrrolidone, polyether, polyether sulphone, hexafluoropolypropylene, styrene-butadiene rubber and carboxymethyl cellulose. The binder may be a copolymer of two or more materials selected from the group consisting of tetrafluoroethylene, hexafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid and hexadiene. A mixture of these materials may also be used.

Examples of the conductive agent may include graphites such as natural graphite and artificial graphite, carbon blacks such as acetylene black (AB), Ketjen black, channel black, furnace black, lamp black and thermal black, conductive fibers such as carbon fiber and metal fiber, metal powders such as carbon fluoride and aluminum, conductive whiskers such as zinc oxide and potassium titanate, conductive metal oxides such as titanium oxide and organic conductive materials such as a phenylene derivative.

The ratio of the active material, conductive agent and binder in the positive electrode material mixture layer 52 is not particularly limited and they may be contained in the known ratio in the positive electrode material mixture layer 52.

Now, the porous insulating layer 7 will be detailed. When metal oxide is used as the high heat resistant material and secondary particles are obtained by bonding primary particles with a binder, the filling factor of the metal oxide in the porous insulating layer 7 is reduced. As a result, the porosity of the porous insulating layer 7 increases, which gives high lithium ion permeability to the porous insulating layer 7. The secondary particles are preferably prepared by sintering or dissolving and recrystallizing part of the primary metal oxide particles. The secondary particles may be chain particles or layered particles. The dissolution and recrystallization process is a process of dissolving the metal oxide in a solvent and then recrystallizing it to bond the primary particles together. The diameter of the primary particle is preferably 0.01 μm to 0.5 μm, both inclusive. The size of the primary particle (diameter of a chain particle or width of a flake-like particle) can be measured using an SEM (scanning electron microscope).

The secondary particles can be manufactured by various methods, such as a chemical method of dissolving the primary particles entirely or partially using a chemical agent and then recrystallizing them or a physical method of applying external pressure to the primary particles. Among them, a simple method is to raise the temperature close to the melting point of the primary particles and then bond them together. If the secondary particles are prepared by this method, binding force between the primary particles in a partially melting state is preferably set high enough not to crush the primary particles while melting and stirring them to prepare paste. If the bulk density of the particles increases in the dissolution and recrystallization process, the strength of the porous insulating layer is reduced. Therefore, the primary particles preferably have low bulk density.

The binder for binding the high heat resistance material particles is preferably a polymer resin. The polymer resin belongs to acrylates and preferably contains a methacrylate polymer or a methacrylate copolymer. More specifically, examples of the polymer resin may include PVDF, polytetrafluoroethylene, polyethylene, polypropylene, aramid resin, polyamide, polyimide, polyamide-imide, polyacrylonitrile, polyacrylic acid, polyacrylic acid methyl ester, polyacrylic acid ethyl ester, polyacrylic acid hexyl ester, polymethacrylic acid, polymethacrylic acid methyl ester, polymethacrylic acid ethyl ester, polymethacrylic acid hexyl ester, polyvinyl acetate, polyvinyl pyrrolidone, polyether, polyether sulphone, hexafluoropolypropylene, styrene-butadiene rubber and carboxymethyl cellulose. The binder may be a copolymer of two or more materials selected from the group consisting of tetrafluoroethylene, hexafluoroethylene, hexafluoropropylene, perfluoroalkylvinylether, vinylidene fluoride, chlorotrifluoroethylene, ethylene, propylene, pentafluoropropylene, fluoromethylvinylether, acrylic acid and hexadiene. A mixture of two or more of these materials may also be used.

The thickness of the porous insulating layer 7 is generally 10 μm to 300 μm, both inclusive. However, the thickness is preferably 10 pm to 40 μm, both inclusive, more preferably 15 μm to 30 μm, both inclusive, still more preferably 10 μm to 25 μm, both inclusive. If a thin microporous film is used as the porous insulating layer 7, the thin microporous film may be a monolayer film made of a single material, a multilayer film made of a single material or a composite film made of two or more materials. The porosity of the porous insulating layer 7 is preferably 30% to 70%, both inclusive, more preferably 35% to 60%, both inclusive. The porosity is the volume ratio of the pores to the porous insulating layer.

The nonaqueous electrolyte may be a liquid nonaqueous electrolyte, a gelled nonaqueous electrolyte or a solid electrolyte (solid polymer electrolyte).

The liquid nonaqueous electrolyte is prepared by dissolving an electrolyte (e.g., lithium salt) in a nonaqueous solvent. The gelled nonaqueous electrolyte contains a nonaqueous electrolyte and a polymer material supporting the nonaqueous electrolyte. The polymer material supporting the nonaqueous electrolyte may be, for example, polyvinylidene fluoride, polyacrylonitrile, polyethylene oxide, polyvinyl chloride, polyacrylate or polyvinylidene fluoride hexafluoropropylene.

A known nonaqueous solvent can be used as the nonaqueous solvent for dissolving the electrolyte. The nonaqueous solvent is not particularly limited and examples thereof may include cyclic carbonate, chain carbonate and cyclic carboxylate. Cyclic carbonate may be propylene carbonate (PC) and ethylene carbonate (EC). The chain carbonate may be diethyl carbonate (DEC), ethylmethyl carbonate (EMC) and dimethyl carbonate (DMC). The cyclic carboxylate may be γ-butyrolactone (GBL) and γ-valerolactone (GVL). One of the examples of the nonaqueous solvent may be used solely or two or more of them may be used in combination.

Examples of the electrolyte to be dissolved in the nonaqueous solvent may include LiClO₄, LiBF₄, LiPF₆, LiAlCl₄, LiSbF₆, LiSCN, LiCF₃SO₃, LiCF₃CO₂, LiAsF₆, LiB₁₀Cl₁₀, lower aliphatic lithium carboxylate, LiCl, LiBr, LiI, chloroborane lithium, borates and imidates. Examples of the borates include bis(1,2-benzene diorate(2-)-O,O′)lithium borate, bis(2,3-naphthalene diorate(2-)-O,O′)lithium borate, bis(2,2′-biphenyl diorate(2-)-O,O′)lithium borate and bis(5-fluoro-2-orate-1-benzenesulfonic acid-O,O′)lithium borate. Examples of the imidates include lithium bistrifluoromethanesulfonimide ((CF₃SO₂)₂NLi), lithium trifluoromethanesulfonate nonafluorobutanesulfonimide (LiN(CF₃SO₂)(C₄F₉SO₂)) and lithium bispentafluoroethanesulfonimide ((C₂F₅SO₂)₂NLi). One of these electrolytes may be used solely or two or more of them may be used in combination.

The nonaqueous electrolyte may further contain, as an additive, a material which is decomposed on the negative electrode 6 and forms thereon a coating having high lithium ion conductivity for enhancing the charge-discharge efficiency. Examples of the additive having such a function may include vinylene carbonate (VC), 4-methylvinylene carbonate, 4,5-dimethylvinylene carbonate, 4-ethylvinylene carbonate, 4,5-diethylvinylene carbonate, 4-propylvinylene carbonate, 4,5-dipropylvinylene carbonate, 4-phenylvinylene carbonate, 4,5-diphenylvinylene carbonate, vinylethylene carbonate (VEC) and divinylethylene carbonate. One of the additives may be used solely or two or more of them may be used in combination. Among the additives, at least one selected from the group consisting of vinylene carbonate, vinylethylene carbonate and divinylethylene carbonate is preferable. In the above-listed compounds, part of a hydrogen atom may be substituted with a fluorine atom. The amount of the electrolyte dissolved in the nonaqueous solvent is preferably 0.5 mol/m³ to 2 mol/m³, both inclusive.

The nonaqueous electrolyte may further contain a benzene derivative. The benzene derivative is decomposed during the overcharge and forms a coating on the electrode plate. As a result, the lithium ion secondary battery is inactivated. The benzene derivative preferably has a phenyl group and a cyclic compound group adjacent to the phenyl group. The cyclic compound group may preferably be a phenyl group, a cyclic ether group, a cyclic ester group, a cycloalkyl group or a phenoxy group. Examples of the benzene derivative may include cyclohexylbenzene, biphenyl and diphenyl ether. One of the benzene derivatives may be used solely or two or more of them may be used in combination. However, the content of the benzene derivative is preferably not higher than 10 vol % of the total volume of the nonaqueous solvent.

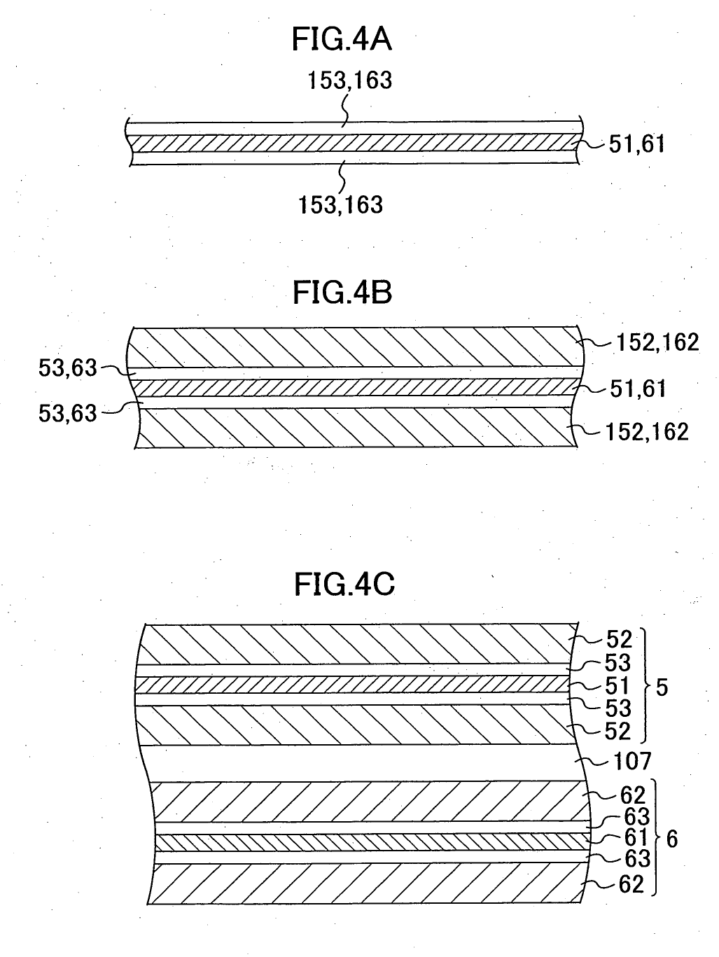

FIGS. 4A to 4C are sectional views illustrating the method for manufacturing the lithium ion secondary battery of the present embodiment.

For the manufacture of the lithium ion secondary battery of the present embodiment, a PTC layer material 153 is provided on both surfaces of the positive electrode collector 51 and a PTC layer material 163 is provided on both surfaces of the negative electrode collector 61 as shown in FIG. 4A (step (a)). It is preferable that the PTC layer material 153 covers the entire surfaces of the positive electrode collector 51 and the PTC layer material 163 covers the entire surfaces of the negative electrode collector 61. The PTC layer materials 153 and 163 may be provided by a known method. For example, a material having a positive temperature coefficient of resistance, a binder and a solvent are mixed to prepare paste. The paste is applied to the surfaces of the positive electrode collector 51 and the negative electrode collector 61 and then dried. In this way, the PTC layers 53 are formed on the both surfaces of the positive electrode collector 51 and the PTC layers 63 are formed on the both surfaces of the negative electrode collector 61.

Then, as shown in FIG. 4B, a positive electrode material mixture 152 is provided on the PTC layers 53, while a negative electrode material mixture 162 is provided on the PTC layers 63 (step (b)). The electrode material mixtures may be provided by a known method. For example, the positive electrode material mixture 152 is provided by mixing a positive electrode material (containing a binder and a conductive material) and a positive electrode active material into a solvent to form a positive electrode material mixture slurry, applying the slurry on the surfaces of the PTC layers 53 and drying the slurry. Likewise, the negative electrode material mixture 162 is provided by mixing a negative electrode material (containing a binder) and a negative electrode active material into a solvent to prepare a negative electrode material mixture slurry, applying the slurry on the surfaces of the PTC layers 63 and drying the slurry. In this way, the PTC layers 53 and the positive electrode material mixture layers 52 are sequentially stacked on the surfaces of the positive electrode collector 51 to provide the positive electrode 5. Further, the PTC layers 63 and the negative electrode material mixture layers 62 are sequentially stacked on the surfaces of the negative electrode collector 61 to provide the negative electrode 6.

Then, as shown in FIG. 4C, the positive and negative electrodes 5 and 6 are arranged to face each other and a porous insulating layer material 107 (high heat resistance material in this embodiment) is provided between the positive and negative electrodes 5 and 6 (step (c)). The porous insulating layer material 107 may be provided by a known method such as dipping, spraying or printing. The dipping is performed by dipping the electrode plate into a solution mixture prepared by uniformly dispersing the porous insulating layer material 107 and a binder into a solvent. The spraying is carried out by spraying the solution mixture onto the surface of the electrode material mixture layer. The printing is to print the solution mixture onto the entire surface of the electrode plate. It is preferable that the porous insulating layer material 107 is adhered onto the surfaces of the positive electrode material mixture layer 52 and the negative electrode material mixture layer 62.

Though not shown, the positive and negative electrodes 5 and 6 bonded to each other are wound to obtain an electrode group and the obtained electrode group is placed in a battery case. Then, the nonaqueous electrolyte is poured into the battery case and the battery case is sealed. Thus, the lithium ion secondary battery of the present embodiment is obtained.

As described above, the lithium ion secondary battery of the present embodiment includes the porous insulating layer 7 and the PTC layers 53 and 63. Therefore, even when the internal or external short circuit occurs or the lithium ion secondary battery is overcharged, the safety of the lithium ion secondary battery is ensured.

### Second Embodiment

In Embodiment 2, a porous insulating layer material different from that used in Embodiment 1 is used. Hereinafter, the difference between Embodiments 1 and 2 will be described.

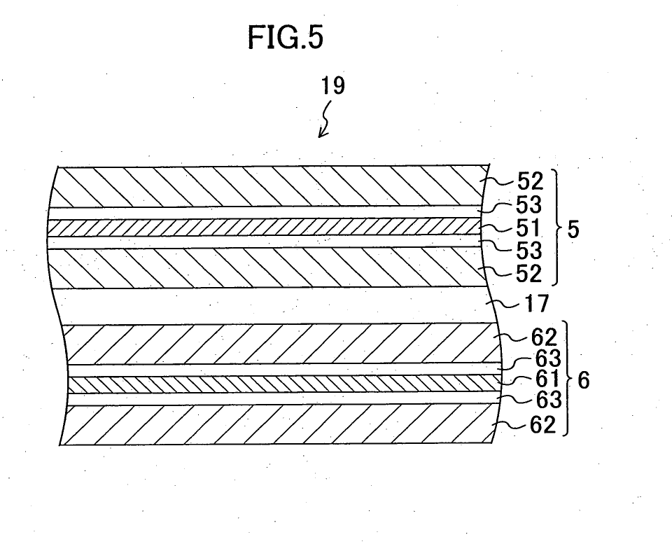

FIG. 5 is a sectional view illustrating the structure of an electrode group 19 of the present embodiment.

The electrode group 19 of the present embodiment includes, just like that of Embodiment 1, a positive electrode 5, a negative electrode 6 and a porous insulating layer 17. The positive electrode 5 includes PTC layers 53 and the negative electrode 6 includes PTC layers 63. The porous insulating layer 17 contains a material which does not have a shutdown function (not shown).

According to the present embodiment, the material which does not have a shutdown function is a material which does not cause shutdown at a temperature lower than 130° C. but causes the shutdown at a temperature not lower than 130° C. The material which does not have the shutdown function of the present embodiment is less heat resistant than the high heat resistant material of Embodiment 1. Therefore, the material of the present embodiment is referred to as a low heat resistant material.

The low heat resistant material is a material which melts or thermally decomposes at a temperature not lower than 130° C., such as polypropylene having more excellent heat resistance than polyethylene.

The lithium ion secondary battery of the present embodiment behaves in the same manner as that of Embodiment 1 when the battery is overcharged or the external short circuit occurs in the battery. Therefore, in the following description, the case where the internal short circuit occurs in the lithium ion secondary battery of the present embodiment will be explained.

When the internal short circuit occurs in the lithium ion secondary battery of the present embodiment, the temperature of the lithium ion secondary battery abruptly increases. At this time, the PTC layers 53 and 63 cannot increase their resistance values along with the temperature rise. However, since the porous insulating layer 17 is less likely to melt than the polyethylene separator, the lithium ion secondary battery of the present embodiment is able to prevent the increase of the contact area between the positive and negative electrodes 5 and 6 more effectively than the conventional lithium ion secondary battery even if the lithium ion secondary battery falls into an abnormal state.

### Third Embodiment

In Embodiment 3, the structure and the manufacturing method of the electrode group are different from those of Embodiment 1. In the following description, the difference from Embodiment 1 will be explained.

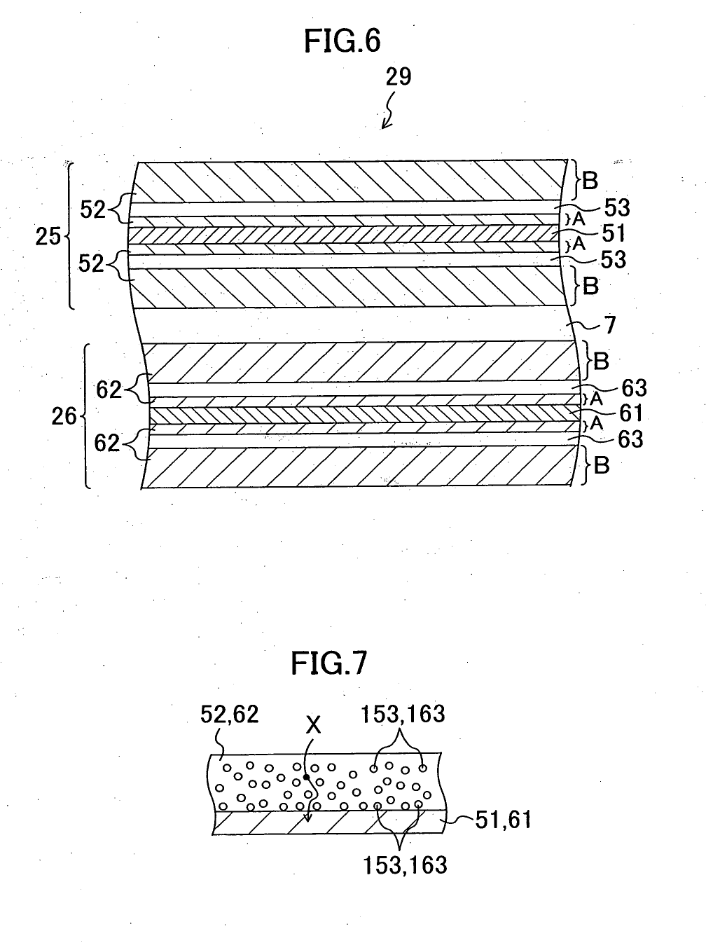

FIG. 6 is a sectional view illustrating the structure of an electrode group 29 of the present embodiment and FIG. 7 is a sectional view illustrating part of an electrode group of a comparative embodiment.

The electrode group 29 of the present embodiment includes a positive electrode 25, a negative electrode 26 and a porous insulating layer 7. The positive electrode 25 includes PTC layers 53 and the negative electrode 26 includes PTC layers 63.

The PTC layers 53 and 63 contain a material having a positive temperature coefficient of resistance, respectively, just like those of Embodiment 1. However, unlike the PTC layers of Embodiment 1, the PTC layers 53 are provided in the positive electrode material mixture layers 52, respectively, and the PTC layers 63 are provided in the negative electrode material mixture layers 62, respectively.

The material having the positive temperature coefficient of resistance provided in the positive electrode material mixture layers 52 and the negative electrode material mixture layers 62 may be in the form of a layer as shown in FIG. 6 or dispersed in the electrode material mixture as shown in FIG. 7. For the following reason, the structure shown in FIG. 6 is preferable.

In the structure of FIG. 6, the PTC layer 53 is not provided between a region A of the positive electrode material mixture layer and the positive electrode collector 51. Therefore, when the short circuit occurs, electron conduction between the positive electrode active material in the region A and the positive electrode collector 51 may not be interrupted. Likewise, since the PTC layer 63 is not provided between a region A of the negative electrode material mixture layer and the negative electrode collector 61, electron conduction between the negative electrode active material in the region A and the negative electrode collector 61 may not be interrupted. In contrast, the PTC layer 53 is provided between a region B of the positive electrode material mixture layer and the positive electrode collector 51. Therefore, electron conduction between the positive electrode active material in the region B and the positive electrode collector 51 is interrupted. Further, since the PTC layer 63 is provided between a region B of the negative electrode material mixture layer and the negative electrode collector 61, electron conduction between the negative electrode active material in the region B and the negative electrode collector 61 is interrupted. Thus, the lithium ion secondary battery of FIG. 6 ensures the safety with higher reliability as compared with the lithium ion secondary battery in which the PTC layer is not provided.

The thinner the region A is, the more reliably the PTC layer 53 interrupts the electron conduction between the positive electrode active material and the positive electrode collector 51 and the PTC layer 63 interrupts the electron conduction between the negative electrode active material and the negative electrode collector 61. Therefore, the PTC layer 53 is preferably arranged closer to the positive electrode collector 51 than to the porous insulating layer 7 and the PTC layer 63 is preferably arranged closer to the negative electrode collector 61 than to the porous insulating layer 7. It is most preferable that the PTC layer 53 is provided between the positive electrode collector 51 and the positive electrode material mixture layer 52 and the PTC layer 63 is provided between the negative electrode collector 61 and the negative electrode material mixture layer 62, as described in Embodiment 1.

In the structure shown in FIG. 7, the PTC layer material 153 exists between a point X and the positive electrode collector 51. When the short circuit occurs, large current derived from the short circuit flows along an arrow shown in FIG. 7. If the content of the material having a positive temperature coefficient of resistance in the material mixture layer is increased, the large current flow can be prevented. However, at the same time, the content of the active material in the electrode material mixture layer is inevitably decreased. As a result, the performance of the lithium ion secondary battery may be impaired. For this reason, the structure of FIG. 6 is more preferable than the structure of FIG. 7.

However, as described in Embodiment 1, the material having a positive temperature coefficient of resistance may be dispersed in the PTC layers 53 and 63.

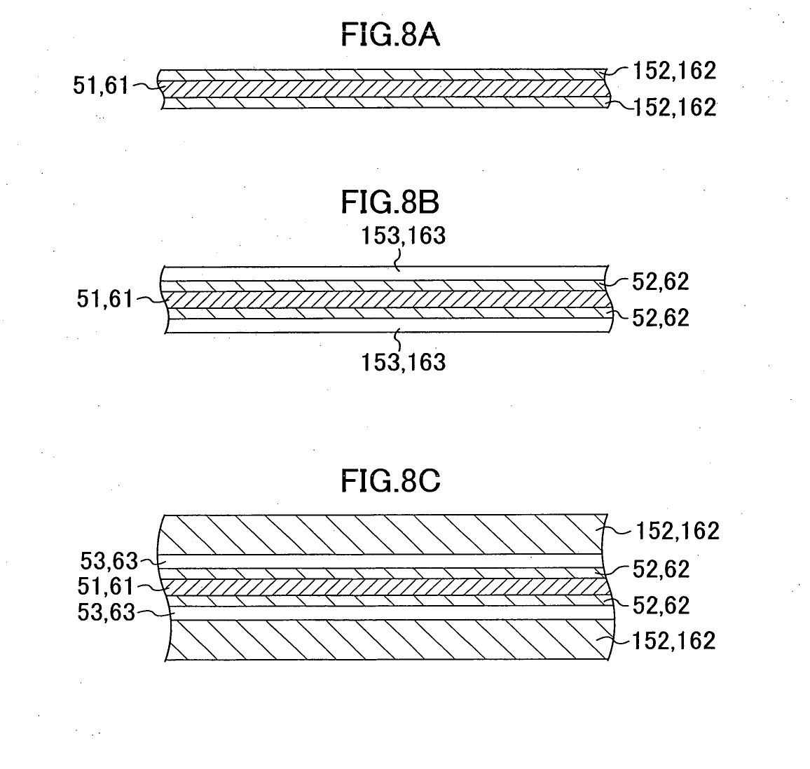

FIGS. 8A to 8C are sectional views illustrating a method for manufacturing the lithium ion secondary battery of the present embodiment.

For the manufacture of the lithium ion secondary battery of the present embodiment, a positive electrode material mixture 152 is provided on both surfaces of the positive electrode collector 51 and a negative electrode material mixture 162 is provided on both surfaces of the negative electrode collector 61 as shown in FIG. 8A (step (d)). In this way, the thinner parts of the positive electrode material mixture layers 52 are formed on the both surfaces of the positive electrode collector 51 and the thinner parts of the negative electrode material mixture layers 62 are formed on the both surfaces of the negative electrode collector 61.

Then, as shown in FIG. 8B, a PTC layer material 153 is provided on the thinner parts of the positive electrode material mixture layers 52 formed in the step shown in FIG. 8A and a PTC layer material 163 is provided on the thinner parts of the negative electrode material mixture layers 62 formed in the step shown in FIG. 8A (step (e)). Thus, the PTC layers 53 and 63 are formed.

Then, as shown in FIG. 8C, the positive electrode material mixture 152 is provided on the PTC layers 53 and the negative electrode material mixture 162 is provided on the PTC layers 63 (step (f)). The positive electrode material mixture 152 and the negative electrode material mixture 162 used in this step are the same as those used in the step shown in FIG. 8A. Thus, the positive electrode material mixture layers 52 are provided on the positive electrode collector 51 with the PTC layers 53 interposed in the positive electrode material mixture layers 52, respectively. Likewise, the negative electrode material mixture layers 62 are provided on the negative electrode collector 61 with the PTC layers 63 interposed in the negative electrode material mixture layers 62, respectively.

Then, according to the step of Embodiment 1 shown in FIG. 4C, the porous insulating layer 7 is provided between the positive electrode material mixture layer 52 and the negative electrode material mixture layer 62 facing each other (step (g)).

After these steps, the lithium ion secondary battery of the present embodiment is completed by a known method.

In the present embodiment, the porous insulating layer of Embodiment 1 is used, but it may be replaced with the porous insulating layer of Embodiment 2.

### Fourth Embodiment

Embodiment 4 is different from Embodiment 1 in the structure of the porous insulating layer. Hereinafter, the difference from Embodiment 1 will be explained.

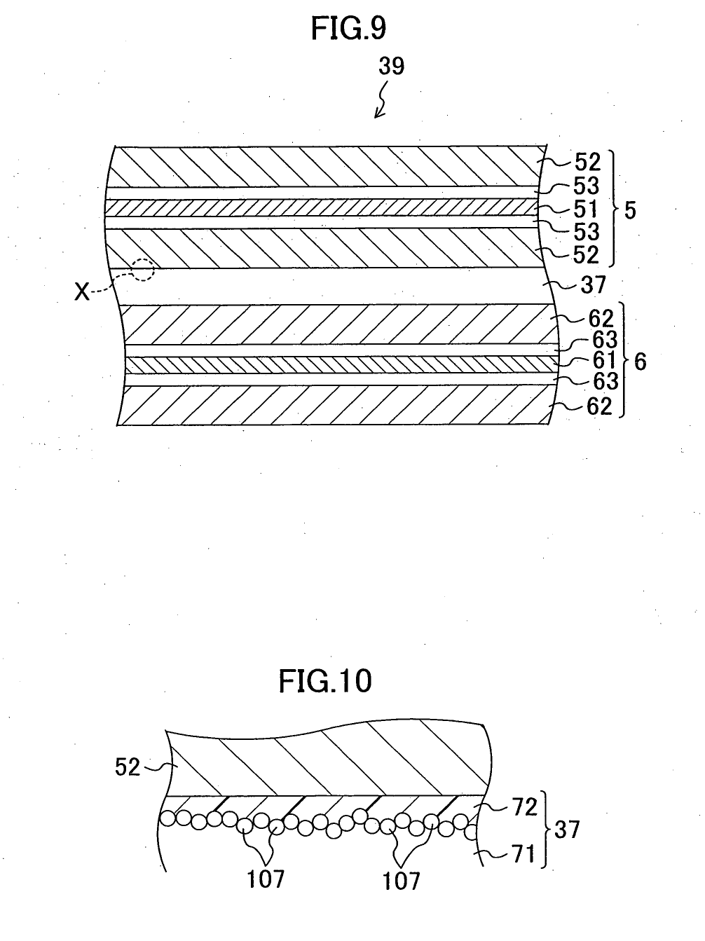

FIG. 9 is a sectional view illustrating the structure of an electrode group 39 of the present embodiment and FIG. 10 is sectional view showing an enlargement of a region X shown in FIG. 9.

The electrode group 39 of the present embodiment includes, just like the electrode group of Embodiment 1, a positive electrode 5, a negative electrode 6 and a porous insulating layer 37. The positive electrode 5 includes PTC layers 53 and the negative electrode 6 includes PTC layers 63. The porous insulating layer 37 includes a metal compound layer 71 containing metal compound particles 107 as the high heat resistant material and intermediate layers 72 formed on both surfaces of the metal compound layer 71. The intermediate layers 72 are omitted from FIG. 9 because they are very thin as compared with the electrode material mixture layers and the collectors.

The metal compound layer 71 is made of the metal compound particles 107 bonded to each other by a binder. Therefore, the surfaces thereof are uneven as shown in FIG. 10. The intermediate layers 72 are provided on the uneven surfaces, respectively, to planarize the surfaces of the porous insulating layer 37. That is, the intermediate layers 72 sandwich the metal compound layer 71. Therefore, as compared with the structure having no intermediate layers 72, the metal compound particles 107 are less likely to fall off the positive electrode material mixture layer 52 or the negative electrode material mixture layer 62 when the electrode group 39 is wound in a spiral. With the provision of the intermediate layers 72, the surfaces of the porous insulating layer 37 are planarized and the adhesion between the metal compound layer 71 and the positive electrode material mixture layer 52 or the negative electrode material mixture layer 62 is enhanced.

Each of the intermediate layers 72 may be a resin layer such as a polyethylene layer. If a resin having heat resistance to a temperature around 100° C. is used as the intermediate layers on the porous insulating layer 37, the resin generates heat when the temperature of the lithium ion secondary battery increases, thereby leading to further temperature rise as described in Embodiment 1. However, if the content of the intermediate layers 72 in the porous insulating layer 37 is kept small so that the intermediate layers do not function as the porous insulating layer 37 (5 μm or less in thickness), the heat generated by the intermediate layers 72, if any, is kept small. Therefore, remarkable temperature rise of the lithium ion secondary battery is prevented.

In the porous insulating layer of the present embodiment, the intermediate layers may be provided on both surfaces of a heat resistant polymer layer made of imide or the like or the intermediate layers may be provided on both surfaces of a polypropylene layer.

The intermediate layer may also be provided on one of the surfaces of the metal compound layer, the heat resistant polymer layer or the polypropylene layer.

The shape of the metal compound particles 107 is not limited to that shown in FIG. 10.

### Other Embodiments

Embodiments 1 to 4 of the present invention may be configured as follows.

The porous insulating layer may contain both of the high heat resistant material and the low heat resistant material.

In Embodiments 1, 2 and 4, the PTC layers are provided between the positive electrode collector and the positive electrode material mixture layer and between the negative electrode collector and the negative electrode material mixture layer. However, the PTC layer may be provided only between the positive electrode collector and the positive electrode material mixture layer, or only between the negative electrode collector and the negative electrode material mixture layer. Likewise, in Embodiment 3, the PTC layers are provided in the positive electrode material mixture layer and in the negative electrode material mixture layer. However, the PTC layer may be provided only in the positive electrode material mixture layer or only in the negative electrode material mixture layer.

Although the lithium ion secondary battery in a cylindrical form is explained in the above description, the shape of the battery is not particularly limited thereto. The battery may be configured in a layered structure or a flat shape.

### EXAMPLES

In the following examples, cylindrical lithium ion secondary batteries shown in FIG. 1 were manufactured and they were examined by a nail penetration test and an overcharge test.

### 1. Method for Manufacturing Lithium Ion Secondary Battery

### Example 1

### Manufacture of Positive Electrode

First, a PTC layer material was prepared. Specifically, 4 parts by weight of polyacrylic acid derivative (binder) and a proper quantity of N-methyl-2-pyrrolidone (abbreviated as NMP) (dispersion medium) were mixed into 100 parts by weight of BaTiLa_{0.1}O₂ (PTC layer material) having an average particle diameter of 2 μm to obtain slurry (nonvolatile matter: 30 wt %). In this example, the mixture of the BaTiLa_{0.1}l O₂ particles, the polyacrylic acid derivative and NMP was stirred using a medialess disperser named “CLEAR MIX (trade name)” manufactured by M-Technique until the BaTiLa_{0.1}O₂ particles, the polyacrylic acid derivative and NMP were uniformly dispersed.

Then, the slurry was applied to both surfaces of a 15 μm thick aluminum foil (positive electrode collector) using a gravure roll and dried at 120° C. such that the BaTiLa_{0.1}O₂ particles were scattered on the surface of the positive electrode collector. In this way, a BaTiLa_{0.1}O₂ layer was formed on the surface of the positive electrode collector. The amount of BaTiLa_{0.1}O₂ scattered on the surface of the positive electrode collector was 1 cm³/m² per surface.

Then, 1.7 parts by weight of polyvinylidene fluoride (PVDF) (binder) was dissolved in N-methyl-2-pyrrolidone (NMP) to prepare a binder solution, to which 1.25 parts by weight of acetylene black was mixed to prepare a conductive agent.

To the obtained conductive agent, 100 parts by weight of LiNi_{0.80}Co_{0.10}Al_{0.10}O₂ (positive electrode active material) was mixed to obtain positive electrode material mixture paste. The positive electrode material mixture paste was applied to the both surfaces of the 15 μm thick aluminum foil and dried. Then, the obtained product was rolled and cut. Thus, a positive electrode of 0.125 mm in thickness, 57 mm in width and 700 mm in length was obtained.

### (Manufacture of Negative Electrode)

First, mesophase microspheres were graphitized at a high temperature of 2800° C. (hereinafter abbreviated as mesophase graphite) to prepare a negative electrode active material. Then, 100 parts by weight of mesophase graphite, 2.5 parts by weight of BM-400B which is acrylic acid-modified SBR manufactured by ZEON Corporation (solid content: 40 parts by weight), 1 part by weight of carboxylmethyl cellulose and a proper quantity of water were stirred using a dual-arm kneader to prepare negative electrode material mixture paste. The negative electrode material mixture paste was then applied to both surfaces of a collector made of a 18 μm thick Cu foil, followed by drying and rolling. Thus, a 0.02 mm thick negative electrode was obtained.

Then, a porous insulating material was prepared. Specifically, 4 parts by weight of polyacrylic acid derivative (binder) and a proper quantity of NMP (dispersion medium) were mixed into 100 parts by weight of certain polycrystalline alumina particles to prepare insulating slurry containing 60 wt % of nonvolatile matter (porous insulting material).

The mixture of the polycrystalline alumina particles, the polyacrylic acid derivative and NMP was stirred using a medialess disperser named “CLEAR MIX (trade name)” manufactured by M-Technique to obtain the insulating slurry in which the polycrystalline alumina particles, the polyacrylic acid derivative and NMP were uniformly dispersed.

Then, the insulating slurry was applied to both surfaces of the negative electrode by gravure coating and dried with hot air of 120° C. at 0.5 m/sec. As a result, a 20 μm thick porous insulating layer was formed on the surfaces of the negative electrode. The electrode was then cut into the size of 59 mm in width and 750 mm in length and a lead tab for drawing current was welded thereto. Thus, an alumina-coated negative electrode was formed.

### (Preparation of Nonaqueous Electrolyte Solution)

To a solution mixture containing ethylene carbonate and dimethyl carbonate in the volume ratio of 1:3, 5 wt % of vinylene carbonate was added and LiPF₆ in a concentration of 1.4 mol/m³ was dissolved to obtain a nonaqueous electrolyte solution.

(Preparation of cylindrical lithium ion secondary battery)

The positive and negative electrodes were arranged such that alumina on the negative electrode surface was sandwiched between the positive and negative electrodes and they were wound together in a spiral to form an electrode group.

Then, insulators were arranged on the top and bottom of the electrode group, a negative electrode lead was welded to a battery case and a positive electrode lead was welded to a sealing plate having a safety valve operated by internal pressure. Then, the positive and negative electrode leads were contained in the battery case.

Further, the nonaqueous electrolyte solution was poured into the battery case under reduced pressure. Then, an opening end of the battery case was crimped to the sealing plate with a gasket interposed therebetween to complete the lithium ion secondary battery of Example 1.

The capacity of the obtained cylindrical lithium ion secondary battery was 2900 mAh. For the measurement of the battery capacity, the battery was charged up to 4.2 V at a constant current of 1.4 A, charged at a constant voltage of 4.2 V up to a current value of 50 mA and then discharged to 2.5 V at a constant current of 0.56 A in an environment of 25° C.

The lithium ion secondary battery of Example 1 was not provided with CID.

### Example 2

A lithium ion secondary battery of Example 2 was completed in the same manner as Example 1 except that the alumina layer (porous insulating layer, 20 μm thick) was formed not on the negative electrode surface but on the positive electrode surface.

### Example 3

A lithium ion secondary battery of Example 3 was completed in the same manner as Example 1 except that a polypropylene separator (20 μm thick) was used in place of the alumina layer as the porous insulating layer.

### Example 4

A lithium ion secondary battery of Example 4 was completed in the same manner as Example 1 except that an aramid separator (20 μm thick) was used in place of the alumina layer as the porous insulating layer.

### Comparative Example 1

A lithium ion secondary battery of Comparative Example 1 was completed in the same manner as Example 1 except that a polyethylene separator (20 μm thick) was used in place of the alumina layer as the porous insulating layer.

### Comparative Example 2

A lithium ion secondary battery of Comparative Example 2 was completed in the same manner as Example 1 except that the BaTiLa_{0.1}O₂ particles were not scattered on the surface of the positive electrode collector.

### Comparative Example 3

A lithium ion secondary battery of Comparative Example 3 was completed in the same manner as Example 1 except that the BaTiLa_{0.1}O₂ particles were not scattered on the surface of the positive electrode collector and a polyethylene separator (20 μm thick) was used in place of the alumina layer as the porous insulating layer.

### 2. Evaluation of Lithium Ion Secondary Battery

### (Nail Penetration Test)

The lithium ion secondary batteries of Examples 1 to 4 and Comparative Examples 1 to 3 were examined by a nail penetration test.

First, the lithium ion secondary batteries were charged at a constant current of 1.45 A up to a voltage of 4.25 V. After the voltage reached 4.25 V, the batteries were charged at a constant voltage to a current of 50 mA.

Then, a nail of 2.7 mm in diameter was pierced in the middle of the lithium ion secondary battery at 5 mm/sec in the environments of 30° C., 45° C. and 60° C. and 300 mm/sec in the environment of 70° C. to examine whether smoke was generated from the lithium ion secondary battery, i.e., whether a safety valve of the lithium ion secondary battery was actuated and the smoke was generated in the lithium ion secondary battery.

### (Overcharge Test)

The lithium ion secondary battery was continuously charged at a constant current of 1.45 A to inspect a change in electrode temperature and observe the appearance of the lithium ion secondary battery. The upper limit voltage to be applied to the lithium ion secondary battery was 60 V. When the smoke was not observed from the lithium ion secondary battery, the maximum temperature was measured on the surface of the lithium ion secondary battery.

### 3. Results and Discussion

The results are shown in Table 1. The results of the nail penetration test are indicated in the column of the number of batteries that caused smoke and the results of the overcharge test are indicated in the overcharge column. In the column of the number of batteries that caused smoke, the denominator is the number of tested lithium ion secondary batteries and the numerator is the number of lithium ion secondary batteries that caused smoke. The temperature indicated in the overcharge column is the maximum temperature of the battery that did not cause smoke and symbol× indicates that the smoke occurred.

TABLE 1

| | Porous | | Number of batteries that caused | | | | |
|---|---|---|---|---|---|---|---|
| | Insulating | | smoke in nail penetration test | | | | |
| | layer material | PTC layer | 30° C. | 45° C. | 60° C. | 70° C. | Overcharge |
| Ex. 1 | Alumina adhered to | Provided | 0/5 | 0/5 | 0/5 | 0/5 | 115° C. |
| | negative electrode | | | | | | |
| | surface | | | | | | |
| Ex. 2 | Alumina adhered to | Provided | 0/5 | 0/5 | 0/5 | 0/5 | 115° C. |
| | positive electrode | | | | | | |
| | surface | | | | | | |
| Ex. 3 | PP | Provided | 0/5 | 0/5 | 2/5 | 5/5 | 115° C. |
| Ex. 4 | Aramid | Provided | 0/5 | 0/5 | 0/5 | 2/5 | 115° C. |
| Com. Ex. 1 | PE | Provided | 0/5 | 5/5 | 5/5 | 5/5 | 110° C. |
| Com. Ex. 2 | Alumina adhered to | Not | 0/5 | 0/5 | 0/5 | 0/5 | x |
| | negative electrode | provided | | | | | |
| | surface | | | | | | |
| Com. Ex. 3 | PE | Not | 0/5 | 5/5 | 5/5 | 5/5 | 110° C. |
| | | provided | | | | | |

As a result of the nail penetration test, it was observed that every lithium ion secondary battery including the polyethylene separator as the porous insulating layer (Comparative Examples 1 and 3) caused smoke in the environment of 45° C. That is, the safety of the lithium ion secondary batteries was not ensured.

On the other hand, the lithium ion secondary batteries using the alumina layer as the porous insulating layer (Examples 1 and 2 and Comparative Example 2), those using aramid as the porous insulating layer (Example 4) and those using polypropylene as the porous insulating layer (Example 3) did not cause smoke in any environments.

In the lithium ion secondary batteries of Examples 1 to 4 and Comparative Example 2, the nail was pierced at 5 mm/sec in an environment of 75° C. As a result, none of the batteries of Examples 1 and 2 and Comparative Example 2 caused smoke. This indicates that these lithium ion secondary batteries are remarkably heat resistant. On the other hand, some of the lithium ion secondary batteries of Examples 3 and 4 caused smoke. The number of the lithium ion secondary batteries of Example 4 that caused smoke was smaller than the number of the lithium ion secondary batteries of Example 3 that caused smoke. Therefore, it is confirmed that the porous insulating layer having higher heat resistance makes it possible to reduce the number of the batteries that cause smoke more efficiently and therefore ensures the safety of the lithium ion secondary batteries.

As a result of the overcharge test, the lithium ion secondary batteries provided with the PTC layers (Examples 1 to 4 and Comparative Example 1) did not cause smoke. However, the lithium ion secondary batteries not provided with the PTC layers (Comparative Example 2) caused smoke.

What is claimed is:

1. A nonaqueous electrolyte secondary battery comprising:
a positive electrode including a conductive positive electrode collector and a positive electrode material mixture layer supported on the positive electrode collector and contains lithium composite oxide;
a negative electrode including a conductive negative electrode collector and a negative electrode material mixture layer supported on the negative electrode collector and contains a negative electrode active material capable of electrochemically absorbing and desorbing lithium ions;
a nonaqueous electrolyte supported between the positive electrode and the negative electrode;
a porous insulating layer provided between the positive electrode material mixture layer and the negative electrode material mixture layer and contains a material which does not have a shutdown function; and
a PTC layer provided on at least one of the positive and negative electrodes to extend substantially parallel to at least one of the positive and negative electrode collectors and contains a material having a positive temperature coefficient of resistance.

2. The nonaqueous electrolyte secondary battery of claim 1, wherein the PTC layer is provided at least between the positive electrode material mixture layer and the positive electrode collector or between the negative electrode material mixture layer and the negative electrode collector.

3. The nonaqueous electrolyte secondary battery of claim 1, wherein the positive electrode material mixture layer is provided on a surface of the positive electrode collector,
the negative electrode material mixture layer is provided on a surface of the negative electrode collector and
the PTC layer is provided in at least one of the positive electrode material mixture layer and the negative electrode material mixture layer.

4. The nonaqueous electrolyte secondary battery of claim 1, wherein the material which does not have the shutdown function is at least one of a material which does not cause shutdown at a temperature lower than 130° C. but causes the shutdown at a temperature not lower than 130° C. and a material which does not cause the shutdown even at a temperature not lower than 130° C. and
the material having the positive temperature coefficient of resistance shows a resistance value at a temperature of 80° C. to 130° C., both inclusive, which is 100 times or more higher than its resistance value at room temperature.

5. The nonaqueous electrolyte secondary battery of claim 4, wherein the material having the positive temperature coefficient of resistance is BaTiMO₂ (wherein M is one or more elements of Cr, Pb, Ca, Sr, Ce, Mn, La, Y, Nb and Nd).

6. The nonaqueous electrolyte secondary battery of claim 1, wherein the material which does not have the shutdown function is at least one of a material which does not cause shutdown at a temperature lower than 130° C. but causes the shutdown at a temperature not lower than 130° C. and a material which does not cause the shutdown even at a temperature not lower than 130° C. and
the PTC layer is a polymer PTC layer containing a conductive agent and a polymer material having a melting point of 80° C. to 130° C., both inclusive.

7. The nonaqueous electrolyte secondary battery of claim 1, wherein the material which does not have the shutdown function is a metal compound.

8. The nonaqueous electrolyte secondary battery of claim 7, wherein the porous insulating layer includes
a metal compound layer containing the metal compound and
an intermediate layer provided between the metal compound layer and at least one of the positive electrode material mixture layer and the negative electrode material mixture layer.

9. The nonaqueous electrolyte secondary battery of claim 7, wherein the metal compound is at least one of magnesia (MgO), silica (SiO₂), alumina (Al₂O₃) and zirconia (ZrO₂).

10. The nonaqueous electrolyte secondary battery of claim 1, wherein the material which does not have the shutdown function is a heat resistant polymer.

11. The nonaqueous electrolyte secondary battery of claim 1, wherein the porous insulating layer is adhered to at least one of the positive electrode material mixture layer and the negative electrode material mixture layer.

12. The nonaqueous electrolyte secondary battery of claim 1, wherein the material having the positive temperature coefficient of resistance is scattered in the PTC layer.

13. A method for manufacturing a nonaqueous electrolyte secondary battery comprising the steps of:
(a) providing a PTC layer material containing a material having a positive temperature coefficient of resistance on a surface of a collector;
(b) providing an electrode material mixture containing an active material having the same polarity as the collector on the PTC layer material; and
(c) providing a porous insulating layer material containing a material which does not have a shutdown function on the electrode material mixture.

14. A method for manufacturing a nonaqueous electrolyte secondary battery comprising the steps of:
(d) providing on a surface of a collector an electrode material mixture containing an active material having the same polarity as the collector;
(e) providing a PTC layer material containing a material having a positive temperature coefficient of resistance on the electrode material mixture after the step (d);
(f) providing the electrode material mixture on the PTC layer material; and
(g) providing a porous insulating layer material containing a material which does not have a shutdown function on the electrode material mixture after the step (f).
